(19) United States
(12) Patent Application Publication
(10) Pub. No.: US 2010/0138675 A1
(43) Pub. Date: Jun. 3, 2010

(54) Methods and Systems for Managing Power to Multiple Processors

(75) Inventors: Ayedin Nikazm, Austin, TX (US); Randall E. Juenger, Belton, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: DELL PRODUCTS L.P., Round Rock, TX (US)

(21) Appl. No.: 12/325,261

(22) Filed: Nov. 30, 2008

(51) Int. Cl. G06F 1/26

(52) U.S. Cl. 713/300

(57) ABSTRACT

A system for controlling power to multiple processing cores operating in separate domains in an information handling system (IHS) is provided. The system includes a power regulator that is programmable to output voltage depending on a processor domain and a corresponding performance state. In some instances, one processor may be an integrated graphics processing unit, and another processor may be a discrete graphics processing unit.

### TECHNICAL FIELD

The present disclosure relates generally to the field of information handling systems, and more specifically, to managing power to multiple processors within information handling systems.

### BACKGROUND

As the value and use of information continues to increase, individuals and businesses seek additional ways to process and store information. One option available to users is an information handling system (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In an IHS, multiple processors may be employed to increase computing capabilities and efficiency. For example, multiple processors may provide significant advantages for engaging parallel computational tasks because each processor can perform its own tasks simultaneously and independent of the other processor. In some multi-processor IHSs, the processors may only operate in separate domains, that is, only one processor in the IHS may function at a given time. As another example, an IHS may employ a multiple graphics processing core system using a first processor, such as an integrated graphics processing unit (iGPU), and a second processor, such as a discrete graphics processing unit (dGPU). In such an architecture, the iGPU may draw upon a portion of system memory for use as a frame buffer, for example, while the dGPU may have its own discrete memory. In some instances, only one GPU, either the iGPU or the dGPU, may operate at a time with the dGPU operational during the more graphics intensive and thus, power consuming, tasks. Conversely, the iGPU may operate during times of less graphics intensity in order to help reduce the overall power consumption of the IHS.

For multi-processor IHSs that employ processors operable only in separate domains, current power regulating techniques may primarily consist of providing a dedicated power regulator to each processor. In such an implementation, each power regulator may separately provide power to its corresponding processor, which may therefore indicate that only one power regulator may be functioning at a given time. Consequently, there may exist inefficiencies in costs and in space in having to provide distinct power regulators for each processor in a multi-processor IHS. Thus, a need exists for methods and systems for providing a single power regulator that controls power to multiple processors operating in separate domains.

### SUMMARY

The following presents a general summary of several aspects of the disclosure in order to provide a basic understanding of the disclosure. This summary is merely an overview of the disclosure and is not intended to identify key or critical elements of the disclosure or to delineate the scope of the claims. The following summary presents some concepts of the disclosure in a general form as a prelude to the more detailed description that follows.

One aspect of the disclosure provides for an information handling system (IHS). The IHS may include a first processor operable in a first domain, a second processor operable in a second domain, and system memory in communication with the first processor and the second processor. The IHS may further include a power regulator in communication with the first process and second processor that provides power to the first processor in the first domain and the second processor in the second domain.

The present disclosure also provides another aspect of an IHS. The IHS may include a host complex, which includes an integrated graphics processing unit (iGPU) that is operable in a first domain. The IHS may further include a discrete graphics processing unit (dGPU) operable in a second domain, system memory in communication with the host complex, and a power regulator in communication with the host complex, the iGPU, and the dGPU. Moreover, the power regulator may provide power to the iGPU in the first domain and the dGPU in the second domain.

A further aspect of the disclosure provides a method for managing power to multiple processors in an IHS. The method may include determining a domain and a performance state between a first processor and a second processor. Additionally, the method may also include reporting a parameter associated with the domain and the performance state to a power regulator of the IHS. Finally, the method may provide for outputting a voltage corresponding to the parameter to either the first processor or the second processor.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents a schematic illustrating an information handling system (IHS) in accordance with one aspect of the present disclosure;

FIG. 2 represents a schematic illustrating an architecture for power control of multiple processors in accordance with one aspect of the present disclosure;

FIG. 3 represents a schematic illustrating an architecture for power control of multiple processors in accordance with another aspect of the present disclosure; and

FIG. 4 represents a flow diagram illustrating a process by which power control of multiple processors is provided in accordance with one aspect of the present disclosure.

### DETAILED DESCRIPTION

Before the present systems, methods, and computer-readable media are described, it is to be understood that this disclosure is not limited to the particular apparatus, systems and methods described, as such may vary. One of ordinary skill in the art should understand that the terminology used herein is for the purpose of describing possible aspects, embodiments and/or implementations only, and is not intended to limit the scope of the present disclosure which will be limited only by the appended claims.

It must also be noted that as used herein and in the appended claims, the singular forms “a,” “and,” and “the” may include plural referents unless the context clearly dictates otherwise. Thus, for example, reference to “a device” refers to one or several devices, and reference to “a method of processing” includes reference to equivalent steps and methods known to those skilled in the art, and so forth.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

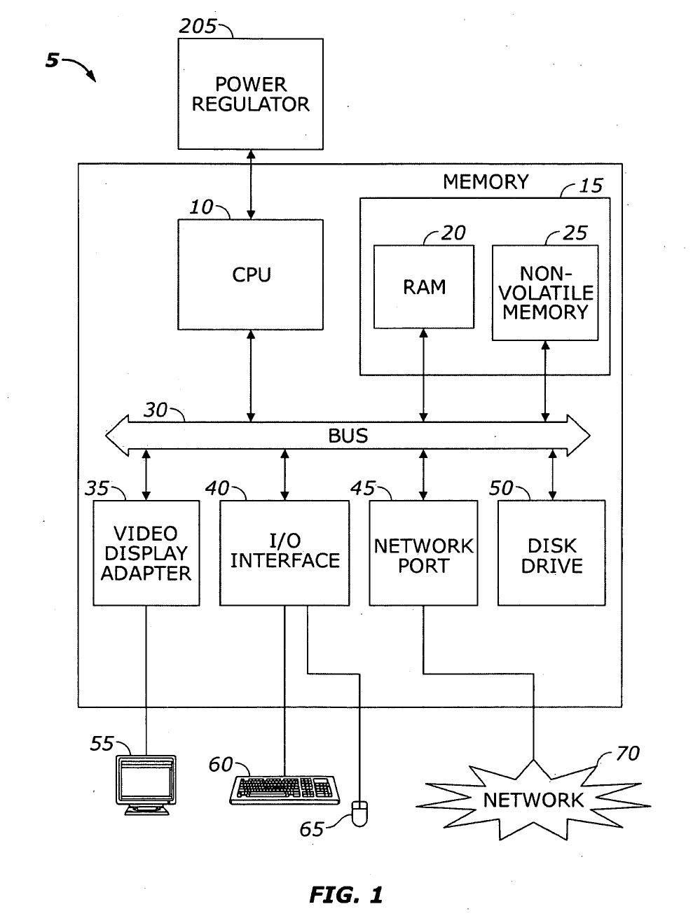

FIG. 1 illustrates one possible implementation of an IHS 5 comprising CPU 10. It should be understood that the present disclosure has applicability to IHSs as broadly described above, and is not intended to be limited to the IHS 5 as specifically described. The CPU 10 or controller may comprise a processor, a microprocessor, minicomputer, or any other suitable device, including combinations and/or a plurality thereof, for executing programmed instructions. It is appreciated that execution of the algorithm to be described below occurs in the processor or the CPU 10. The CPU 10 may be in data communication over a local interface bus 30 with components including memory 15 and input/output interfaces 40. The memory 15, as illustrated, may include non-volatile memory 25. The non-volatile memory 25 may include, but is not limited to, flash memory, non-volatile random access memory (NVRAM), and electrically erasable programmable read-only memory (EEPROM). The non-volatile memory 25 may contain a firmware program (not shown) which may contain programming and/or executable instructions required to control a keyboard 60, mouse 65, video display 55 and/or other input/output devices not shown here. This type of firmware may be known as a basic input/output system (BIOS). The memory may also comprise random access memory (RAM) 20. The operating system and application programs (e.g., graphical user interfaces) may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40. (e.g., keyboard 60, mouse 65).

Furthermore, the IHS 5 may have a power regulator 205 coupled to the CPU 10 to provide a constant level of power to the CPU 10 according to its power requirements. To this end, the power regulator 205 may use a negative feedback loop by comparing its actual output voltage to an internal fixed reference voltage. If the output voltage is less than or below a predetermined level, the power regulator 205 may produce a higher voltage. On the other hand, if the output voltage greater than or above a predetermined level, the power regulator 205 may either produce a lower voltage or stop sourcing current. If the power regulator 205 is chosen to stop sourcing current, it may depend on the current draw of the device it is driving, e.g., CPU 10a-b, to pull the voltage back down. In this manner, the power regulator 205 may maintain the output voltage at a relatively constant level. Additionally, the power regulator 205 may be programmable to output different voltage levels depending on the power requirements of the CPU 10. For example, the CPU 10, in order to conserve power for the IHS 5, may operate at different clock speeds depending on whether a particular task requires intensive use of the CPU 10. More CPU 10 intensive tasks such as mathematical modeling, vector coordination, and other computational intensive applications, may require the CPU 10 to operate at higher clock speeds and higher voltages and vice versa.

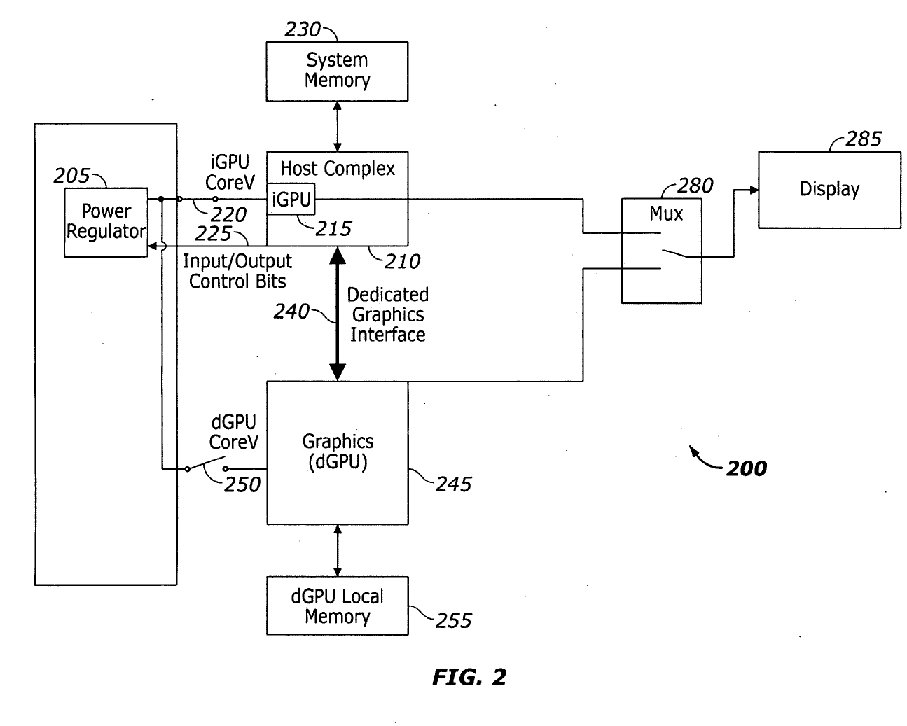

FIG. 2 provides a schematic illustrating an IHS, indicated generally at 200, configured with a single power regulator 205 providing power to two processors, shown as an integrated graphics processing unit (iGPU) 215 and a discrete graphics processing unit (dGPU) 245. The power regulator may be in communication with the iGPU 215 and the dGPU 245 via the iGPU core voltage (corev) rail 220 and the dGPU coreV rail 250, respectively. A graphics processing unit (GPU) may refer to a device in an IHS dedicated to rendering graphics. Thus, a GPU may free the CPU 10 from having to manage display information and enable the CPU 10 to engage in various other tasks. The iGPU 215 may refer to a graphics processing unit that utilizes a portion of system memory 230 to render graphics. The iGPU 215 framework may be in contrast to that of the dGPU 245 which may have its own memory 255 or local frame buffer, for example, dedicated for use only with the dGPU 245. Therefore, because the iGPU 215 may have to share system memory 230 with the CPU 10, the iGPU 215 may generally be employed during less graphics-intensive applications including, but not limited to, word processing, playing movies, and operating system idle states. On the other and, the dGPU 245 may operate for more graphics-intensive applications such as graphics design tools, computer games, and the like. Due to these differences, the iGPU 215 and dGPU 245 may also have varying characteristics such as different clock speeds and may have different core voltage requirements for example. Thus, each GPU may operate in its own separate domain and, power state, i.e., only one of the GPUs may be operational at a given time. Indeed, as depicted in FIG. 2, the switch to the iGPU core voltage rail 220 is closed while the switch to the dGPU core voltage rail 250 is open, indicating that the power regulator 205 is providing power to the iGPU and not the dGPU. The reverse may be true during dGPU operation.

Additionally, each GPU may itself be capable of running at different performance-states (p-states). P-states may generally refer to a processor's ability to operate at lower capability states. Specifically, a processor operating at a particular p-state may have certain attributes reduced or scaled back such as its clock frequency and coreV. For example, a laptop that has been switched to battery-operated mode may trigger its processor(s) to enter into a p-state and reduce its clock frequency and coreV. In this manner, processors having p-state technology may provide power savings to the IHS 5 during times of low processor usage by lowering the aforementioned attributes. For example, while switching from one task to another, the IHS 5 may determine that less of the iGPU 215 may be necessary and may therefore change the p-state of the iGPU 215 to run at a lower clock frequency and core voltage. The reverse may also be true in that the p-state of the iGPU 215 may be changed to increase its clock frequency and core voltage if the IHS 5 determines that more iGPU 215 usage is necessary. Furthermore, it should be noted that the above concepts may also be applied to the dGPU 245 and its p-states. Thus, the output voltage of the power regulator 205 may depend on the GPU domain (i.e. whether the iGPU 215 or dGPU 245 is operating) and the p-state of the GPU that is in operation.

The host complex 210 may refer to a collection of devices that interface with the system memory 230 and may include, for example, the CPU 10, a memory controller (not shown), iGPU 215, and/or the like. The memory controller may be separate from the CPU 10 or may be located on the CPU 10 die itself and may facilitate communication between the CPU 10 and system memory 230. In some instances, the host complex 210 may also be known as the host controller or the Northbridge. The host complex 210 may also interface with other components of the IHS 5 including, but not limited to, the display controller 248 for the dGPU 245, power regulator 205, and a display I/O device 275. In addition, the power regulator 205 may be programmable by the host complex 210 via input/output control bits 225 such as General Purpose Input Output (GPIO) control bits and the like. GPIO control bits may provide an interface for devices such as microprocessors, microcontrollers, and/or the like to interface with other elements of a circuit. Indeed, GPIO control bits may act as inputs to read digital signals or as outputs to control other devices. As illustrated in FIG. 2, the input/output control bits 225 may be set by the host complex 210 to represent a particular GPU domain and its p-state, thereby signaling the power regulator 205 to output the corresponding voltage. As a result, the power regulator 205 may provide power to the iGPU 215 when in the iGPU domain and to the dGPU 245 in the dGPU domain. Specifically, a digital-to-analog converter (DAC, not pictured) may be present within the power regulator 205 to receive the digital signals from the input/output control bits 225 and convert them into the corresponding analog voltage signal. It should be noted that in other implementations, the input/output control bits 225 may be sent specifically from the CPU 10, another device from within the host complex 210, from any input output controller, or any other device. Furthermore, there may be any number of GPIO control bits 225 to indicate the GPU domain and the respective p-states.

The host complex 210 may communicate with the dGPU 245 via a dedicated graphics interface such as a Peripheral Component Interconnect Express Graphics (PEG) interface, for example. PEG may be implemented using multiple point-to-point serial connections, which may be called lanes, and may allow a higher data transmission rate relative to other technologies. Furthermore, it should be noted that other interfaces between the host complex 210 and dGPU 245 may also be contemplated within the present disclosure including, but not limited to, Peripheral Component Interconnect, Peripheral Component Interconnect Extended (PCI-X), and/or Accelerated Graphics Port (AGP).

In addition, a multiplexer 280 may be coupled to the iGPU 215 and the dGPU 245. The multiplexer 280, depending on the GPU domain, may pass display information from either the iGPU 215 or the dGPU 245 on to the display 285. The display may be any type of display including, but not limited to, integrated Liquid Crystal Displays (LCD) such as on a laptop or notebook, standalone LCDs, any other digital monitor, and analog monitors. Furthermore, the present disclosure may contemplate having display information from the iGPU 215 and dGPU 245 pass through any number of multiplexers in combination with any number of display devices.

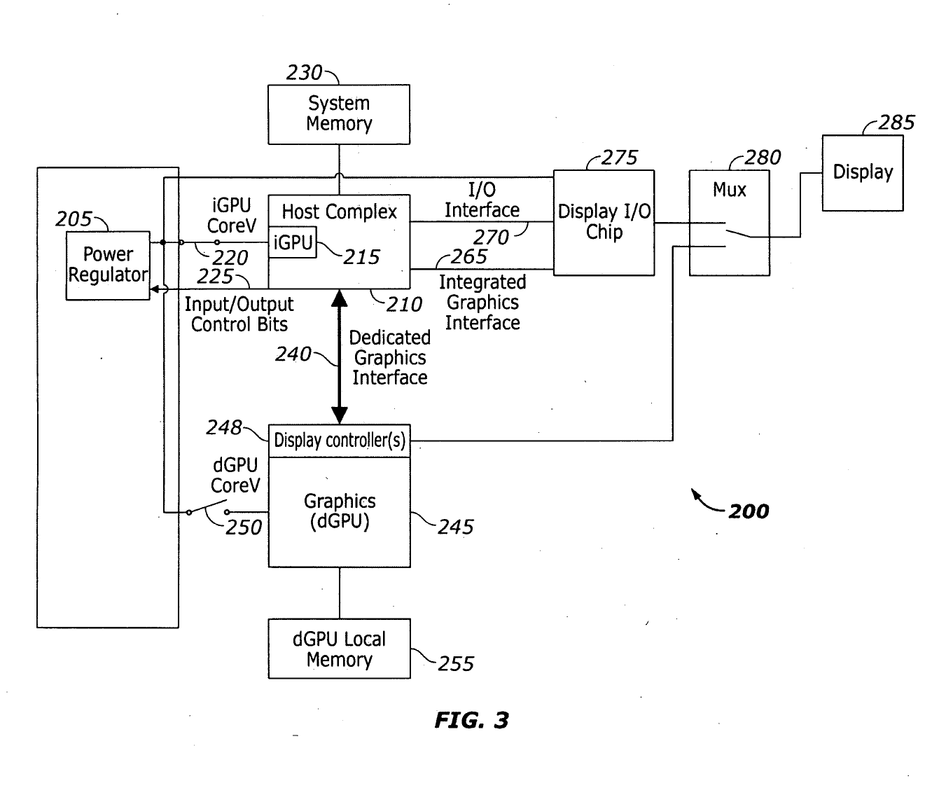

Turning now to FIG. 3 a schematic of another implementation of the present disclosure is shown, indicated generally at 300. FIG. 3 may incorporate all the elements depicted in FIG. 2 and may also include additional components. For example, the host complex 210 may also communicate with a display I/O chip 275 via an input/output (I/O) interface 270 and/or an integrated graphics interface 265. In some instances, the display I/O chip 275 may be referred to as the Platform Controller Hub (PCH) or the Southbridge. The display I/O chip 275 may facilitate interaction between the host complex 210 and various other peripheral connections, e.g. hard disks, CD-ROM drives, network ports, Universal Serial Bus, and the like. To this end, an I/O interface 270 such as a DMI connection, for example, may enable the display I/O chip 275 to manage the flow of information between these peripheral connections and the host complex 210. Moreover, the display I/O chip 275 may also be capable of processing display information from the iGPU 215 in the host complex 210. In order to accomplish this task, an integrated graphics interface 265 such as an FDI connection, for example, may be used rather than passing the display information through the I/O interface 270 or DMI connection. Thus, oversaturation of the I/O interface 270 may be prevented. It should be noted, however, that in some instances, the display I/O chip 275 may in fact use an I/O interface 270 or DMI connection to process display information. Moreover, the display I/O chip 275 may also be capable of managing display information from the dGPU 245 either solely or in addition to information from the iGPU 215. Furthermore, in other implementations, the display I/O chip 275 may not be capable of processing the display information and therefore may not use an FDI 265 connection. For example, management of the display information from the iGPU 215 may be handled by the host complex 215 instead.

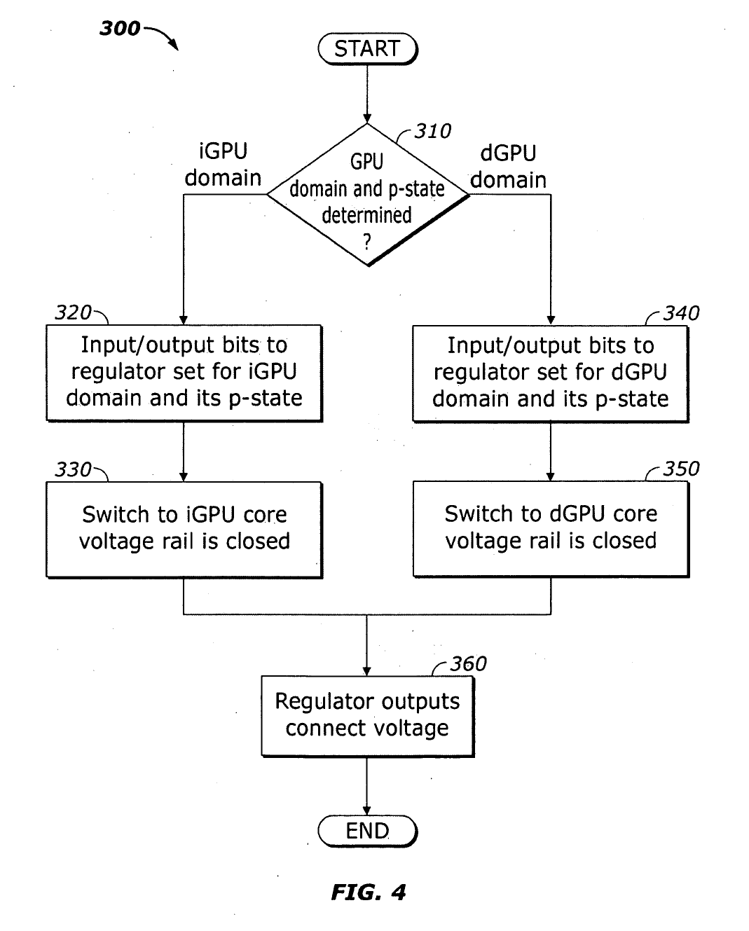

Turning now to FIG. 4, a method for providing power control of multiple processing cores is indicated generally at 400. In step 410, the GPU domain and p-state may be determined. In some instances, this step may be performed by software running in the IHS such as an operating system, BIOS, and/or the like. Other techniques may include making this determination at the hardware level such as by the host complex 210 or CPU 10. Next, if the GPU domain is the IGPU domain, then the input/output bits 225 may be set to indicate an iGPU domain and its corresponding p-state in step 420. As previously mentioned, the input/output bits 225 may be sent by the host complex 210 or components within the host complex 210 such as the CPU 10, an I/O controller, and/or the like. In step 430, the switch to the iGPU core voltage rail may be closed while the switch to the dGPU core voltage rail may be opened, thereby establishing a connection with the power regulator and the iGPU. The power regulator may then output the correct voltage corresponding to the GPU domain and p-state via its DAC in step 460.

On the other hand, if the GPU domain is determined to be the dGPU domain, the input/output bits 225 may then be set to indicate the dGPU domain and its corresponding p-state in step 440. Thus, in step 350, in order to establish a connection between the power regulator and the dGPU core voltage rail, the switch to the dGPU core voltage is closed, and the switch to the iGPU core voltage rail is opened. The power regulator again then outputs the correct voltage corresponding to the GPU domain and p-state in step 460.

While FIGS. 2-4 have described the present disclosure in terms of power regulation between an iGPU and a dGPU, one of ordinary skill in the art would understand that the present disclosure to apply to any architecture having any two or more processors that operate in separate domains. Furthermore, methods of the present disclosure, detailed description and claims may be presented in terms of logic, software or software implemented aspects typically encoded on a variety of media or medium including, but not limited to, computer-readable medium/media, machine-readable medium/media, program storage medium/media or computer program product. Such media, having computer-executable instructions, may be handled, read, sensed and/or interpreted by an IHS. Generally, computer-executable instructions, such as program modules, may include routines, programs, objects, components, data structures, and the like, which perform particular tasks, carry out particular methods or implement particular abstract data types. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

Although the present disclosure has been described with reference to particular examples, embodiments and/or implementations, those skilled in the art will recognize that modifications and variations may be made without departing from the spirit and scope of the claimed subject matter. Such changes in form and detail, including use of equivalent functional and/or structural substitutes for elements described herein, fall within the scope of the appended claims and are intended to be covered by this disclosure.

What is claimed is:

1. An information handling system (IHS) comprising:
a first processor operable in a first domain;
a second processor operable in a second domain;
system memory in communication with the first processor and the second processor; and
a power regulator in communication with the first processor and the second processor, wherein the power regulator provides power to the first processor in the first domain and the second processor in the second domain.

2. The system of claim 1, wherein the first processor is capable of a first plurality of performance states, and wherein the second processor is capable of a second plurality of performance states.

3. The system of claim 2, wherein the power regulator is programmable by at least one input/output (I/O) bit, the at least one I/O bit operable to indicate to the power regulator either the first domain and the first plurality of performance states or the second domain and the second plurality of performance states.

4. The system of claim 3, wherein the at least one input/output bit is an at least one general purpose input/output (GPIO) bit.

5. The system of claim 4, wherein the power regulator outputs a voltage signal corresponding to the at least one GPIO bit.

6. The system of claim 5, wherein the power regulator further comprises a digital-to-analog converter operable to convert the at least one GPIO bit to the voltage signal.

7. The system of claim 1, wherein the first processor and the second processor have different clock speeds and different core voltage requirements.

8. The system of claim 1, wherein the first process is an integrated graphics processing unit (iGPU) and the second processor is discrete graphics processing unit (dGPU).

9. An information handling system (IHS) comprising:
a host complex, wherein the host complex comprises an integrated graphics processing unit (iGPU) operable in a first domain;
a discrete graphics processing unit (dGPU) operable in a second domain;
system memory in communication with the host complex; and
a power regulator in communication with the host complex, the iGPU, and the dGPU, wherein the power regulator is operable to provide power to the iGPU in the first domain and the dGPU in the second domain.

10. The system of claim 9, wherein the iGPU utilizes the system memory to render graphics.

11. The system of claim 9, wherein the dGPU utilizes local memory to render graphics.

12. The system of claim 9, wherein the iGPU is capable of a first plurality of performance states, and wherein the dGPU is capable of a second plurality of performance states.

13. The system of claim 12, wherein the power regulator is programmable by at least one input/output (I/O) bit, the at least one I/O bit operable to indicate to the power regulator either the first domain and the first plurality of performance states or the second domain and the second plurality of performance states.

14. The system of claim 13, wherein the dGPU is in communication with the host complex via a dedicated graphics interface.

15. They system of claim 14, wherein the dedicated graphics interface is selected from the group consisting of Peripheral Component Interconnect Express Graphics, Peripheral Component Interconnect (PCI), Peripheral Component Interconnect Extended (PCI-X) and Accelerated Graphics Port (AGP).

16. The system of claim 15 further comprising a display input/output (I/O) chip in communication with the host complex, the display I/O chip operable to manage display information via an integrated graphics interface and I/O information via an I/O interface between the display I/O chip and the host complex.

17. The system of claim 14, wherein the integrated graphics interface is a Flexible Display Interface and the I/O interface is a Direct Media Interface.

18. A method for managing power to multiple processors in an information handling system (IHS), the method comprising:
determining a domain and a performance state between a first processor and a second processor;
reporting a parameter associated with the domain and the performance state to a power regulator of the IHS; and
outputting a voltage corresponding to the parameter to either the first processor or the second processor.

19. The method of claim 18, wherein each of the first processor and the second processor is selected from a group consisting of an integrated graphics processing unit (iGPU) and a discrete graphics processing unit (dGPU).

20. The method of claim 19, wherein outputting the voltage to the first processor comprises closing a first switch to the first processor and opening a second switch to the second processor.

21. The method of claim 19, wherein the parameter is at least one input output (I/O) bit, the at least one I/O bit operable to indicate to the power regulator the domain and the performance state.
